(19) United States
(12) Patent Application Publication
(10) Pub. No.: US 2026/0189126 A1
(43) Pub. Date: Jul. 2, 2026

(54) POWER SUPPLY SYSTEM WITH MULTIPLE POWER SUPPLY UNITS

(71) Applicant: Advanced Energy Industries, Inc., Denver, CO (US)

(72) Inventors: Israel Gomez Beltran, Kowloon (HK); Rochie Ligaya Sedillo Libby, Pasig City (PH); Yancy Fontanilla Boncato, Metro Manila (PH); James Sigamani, Manila (PH)

(21) Appl. No.: 19/002,001

(22) Filed: Dec. 26, 2024

(51) Int. Cl. H02M 1/00; H02M 1/14

(52) U.S. Cl. CPC H02M 1/0067; H02M 1/0009; H02M 1/0025; H02M 1/0087; H02M 1/14

(57) ABSTRACT

A power supply module comprises a voltage input adapted to receive an input voltage, a voltage converter configured to convert the input voltage into an output voltage, a voltage output adapted to receive the output voltage, and a controller. The controller comprises a voltage trim input configured to receive a voltage trim input signal from a master power supply module, a voltage trim output configured to output a voltage trim output signal to a slave power supply module, and a drive control circuit configured to generate a converter control signal based on the voltage trim input signal. The converter control signal is configured to control an operation of the voltage converter. The controller further comprises an output signal generator configured to generate the voltage trim output signal based on the output voltage.

### TECHNICAL FIELD

Aspects of the disclosure relate to power supply systems and more particularly to connecting multiple power supplies together to provide output power.

### BACKGROUND

A power supply unit (PSU) typically converts an incoming voltage/power into a different output voltage/power. For example, an alternating current (AC) input voltage may be converted to a direct current (DC) voltage for use by electronic equipment. In another example, a first DC input voltage may be converted to a different DC voltage for use by the electronic equipment.

A multi-PSU system may include multiple PSUs coupled together in series, in parallel, or in a combination of series and parallel connections to supply output power to a load. A configurable multi-PSU system capable of meeting various output voltage and current requirements can satisfy the needs of a large number of customers. Balancing the power produced by each PSU to reduce differences between the supplied power among the PSUs helps to improve efficiency and reduce extra load stresses experienced by one or more PSUs if operated to produce more current than others in the system.

### BRIEF STATEMENT

In accordance with one aspect of the present disclosure, a power supply module comprises a voltage input adapted to receive an input voltage, a voltage converter configured to convert the input voltage into an output voltage, a voltage output adapted to receive the output voltage, and a controller. The controller comprises a voltage trim input configured to receive a voltage trim input signal from a master power supply module, a voltage trim output configured to output a voltage trim output signal to a slave power supply module, and a drive control circuit configured to generate a converter control signal based on the voltage trim input signal. The converter control signal is configured to control an operation of the voltage converter. The controller further comprises an output signal generator configured to generate the voltage trim output signal based on the output voltage.

In accordance with another aspect of the present disclosure, a method of controlling a power supply system including first and second power supply modules, each of the first and second power supply modules configured to convert an input power into an output power and comprising a controller configured to operate in a constant voltage source mode and in a constant current source mode. The method comprises operating the first power supply module according to a master operational mode including detecting an output voltage of the output power, generating a first converter control signal based on the output voltage and based on a first reference voltage, controlling the first power supply module based on the first converter control signal to generate the output power of the first power supply module, generating a voltage trim output signal based on the output voltage and based on the first reference voltage, and transmitting the voltage trim output signal to the second power supply module. The method also comprises operating the second power supply module according to a slave operational mode including receiving the voltage trim output signal from the first power supply module, generating a second converter control signal based on the voltage trim output signal and based on a second reference voltage, and controlling the second power supply module based on the second converter control signal to generate the output power of the second power supply module.

In accordance with another aspect of the present disclosure, a power supply unit comprises a first power supply module coupled in series with a second power supply module, each of the first and second power supply modules configured to convert an input power into a respective output power and comprising a voltage converter and a controller. The controllers of the first and second power supply modules are configured to operate in one of a master operational mode and a slave operational mode based on an operational mode designation. In response to operating in the master operational mode, the controllers of the first and second power supply modules are configured to detect an output voltage of the output power of the respective first or second power supply module, generate a first converter control signal based on the output voltage of the respective first or second power supply module and based on a first reference voltage, control the respective first or second power supply module based on the first converter control signal to generate the output power of the respective first or second power supply module, generate a voltage trim output signal based on the output voltage of the respective first or second power supply module and based on the first reference voltage, and transmit the voltage trim output signal to another power supply module. In response to operating in the slave operational mode, the controllers of the first and second power supply modules are configured to receive the voltage trim output signal, generate a second converter control signal based on the voltage trim output signal and based on a second reference voltage, and control the respective first or second power supply module based on the second converter control signal to generate the output power of the respective first or second power supply module.

### BRIEF DESCRIPTION OF THE DRAWINGS

The drawings illustrate embodiments presently contemplated for carrying out the invention.

In the drawings:

FIG. 1 is a schematic block diagram of a power supply module according to one or more embodiments.

FIG. 2 is a plot showing an exemplary voltage-current characteristics curve according to one or more embodiments.

FIG. 3 illustrates a diagram of a power supply unit according to one or more embodiments.

FIG. 4 illustrates a diagram of a power supply unit according to one or more embodiments.

FIG. 5 illustrates a diagram of a power supply unit according to one or more embodiments.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

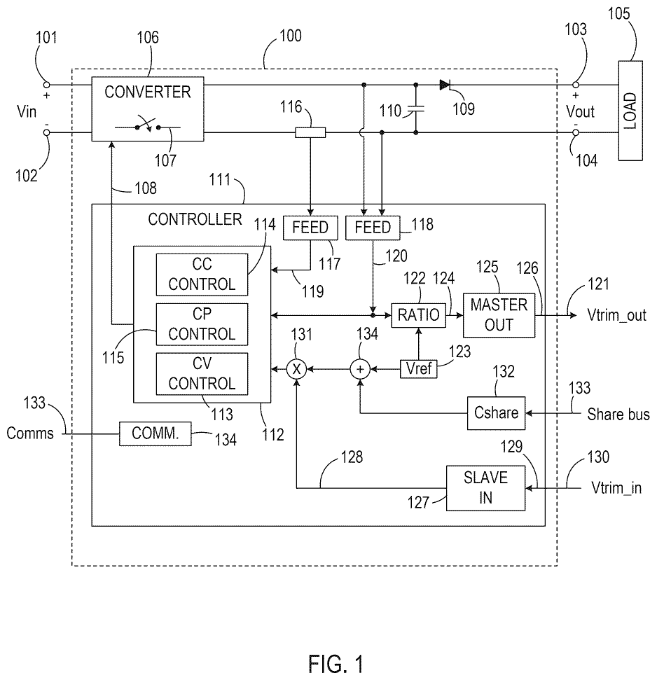

FIG. 1 is a schematic block diagram of a power supply module 100 according to one or more embodiments. The power supply module 100 allows for a control architecture that uses a master and slave functionality for series and parallel configurations as described herein. The master unit provides a control signal that allows slave units to follow the operation of the master unit. The control functions are not limited to constant current (CC) mode but can be extended to other functions such as constant power (CP) mode, droop mode, active current sharing, remote sensing, etc. Different settings can be used for master or slave units in order to meet the functionality needed such as different CC set-points, for example. The power supply module 100 contains the hardware and software/firmware to operate as either a master unit or a slave unit. The designation to operate as a master or slave unit may be determined by fixed hardware, addressing, or a position of the power supply module 100 within a multi-PSU system as described hereinbelow.

The power supply module 100 is configured to convert an incoming voltage or power on power input terminals 101, 102 into a different output voltage or power supplied to power output terminals 103, 104 provided to a load 105. A converter 106, coupled to the power input terminals 101, 102, may be an AC or a DC converter for receiving a variable input voltage Vin. The converter 106 includes one or more switching devices or power switches 107 controllable via a control signal 108 for controlling the power switch 107 to convert the input voltage Vin into an output voltage Vout. Implementation of the converter 106 is contemplated herein as any power converter topology such as a buck topology, a boost topology, a buck-boost topology, a forward topology, a flyback topology, a half bridge topology, a full bridge topology, and/or their resonant counterparts. The power supply module 100 includes an output diode 109 and an output capacitor 110 coupled between the converter 106 and the power output terminals 103, 104.

A controller 111 for generating the control signal 108 is included in the power supply module 100 and includes a drive control circuit 112 including constant voltage (CV) control module 113, a constant current (CC) control module 114, and a constant power (CP) control module 115. Based on an output current of the output power provided by the converter 106, the controller 111 operates the power supply module 100 in a CV mode, a CP mode, or a CC mode. To detect the output current, a current sense resistor 116 is coupled with a current feedback circuit 117. A voltage feedback circuit 118 is configured to measure the output voltage, Vout. The current and voltage feedback circuits 117, 118 may be calibrated during manufacturing to calibrate the control operations of the power supply module 100. Current and voltage feedback signals 119, 120 are provided to the drive control circuit 112 for use by the control modules 113-115.

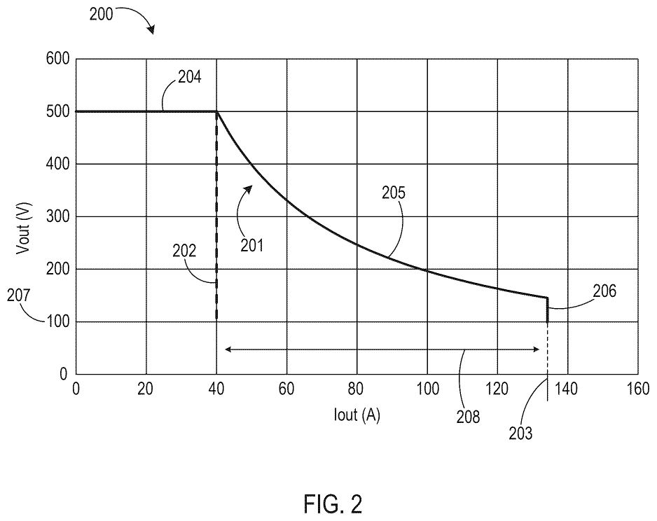

FIG. 2 a plot 200 showing an exemplary voltage-current characteristics curve 201 according to one or more embodiments. The voltage-current characteristics curve 201 illustrates an example of the output voltage, Vout, provided by the power supply module 100 of FIG. 1 during each of the three control modes (e.g., the CV mode, the CP mode, and the CC mode).

Referring to FIGS. 1 and 2, based on the current feedback signal 119 being below both a constant power threshold 202 and a constant current threshold 203, the drive control circuit 112 outputs the control signal 108 as determined by the CV control module 113 to generate a constant voltage. In the example shown in FIG. 2, the constant voltage is 500 V. However, the constant voltage target may be any voltage target capable of being provided by the power supply module 100 as desired by the application in which the power supply module 100 is used. As shown, an example constant power threshold 202 of 40 A is used. Like the constant voltage target, the constant power threshold 202 may be set according to the application of the power supply module 100. The voltage-current characteristics curve 201 includes a constant voltage portion 204 illustrating the characteristics of the output power while the current feedback signal 119 remains under the constant power threshold 202.

In response to the output current reaching or exceeding the constant power threshold 202 (e.g., 40 A) while remaining below the constant current threshold 203, the drive control circuit 112 outputs the control signal 108 as determined by the CP control module 115 to generate the output power as a constant power. In the example shown in FIG. 2, the constant power is 20 KW (e.g., 500 V×40 A). The increase in current may be a result of a resistance or resistive aspect of the load 105 being decreased. In response, the output current is increased. The voltage-current characteristics curve 201 includes a constant power portion 205 illustrating the output power as the current increases toward the constant current threshold 203.

In response to the output current reaching the constant current threshold 203, the drive control circuit 112 outputs the control signal 108 as determined by the CC control module 114 to generate the output power as a constant current. The voltage-current characteristics curve 201 includes a constant current portion 206 illustrating the output current as the voltage decreases toward an undervoltage threshold 207 (e.g., 100 V in the example shown in FIG. 2) under conditions of the load further reducing its resistive aspect. In response to reaching the undervoltage threshold 207, the power supply module 100 may execute a shutdown procedure designed to protect the power supply module 100 against damage.

The constant current threshold 203 is adjustable as illustrated by arrow 208 and may be reduced toward the constant power threshold 202 such that, in some embodiments, the CP mode is not used. For example, the constant current threshold 203 may be moved to the 40 A threshold, sufficiently reducing operation of the power supply module 100 to the CV and the CC modes. The undervoltage threshold 207 is also adjustable as needed based on the architecture of the power supply module 100.

Referring again to FIG. 1, as stated previously, the power supply module 100 allows for a control architecture that uses a master and slave functionality for series and parallel configurations. When configured as a master unit, a master control signal is provided to slave power supply modules via a voltage trim out terminal 121. The voltage feedback signal 120 provided by the voltage feedback circuit 118 is provided to a ratio module 122 that is also coupled to receive a reference voltage 123. The ratio module 122 calculates a ratio of the measured output voltage (based on the voltage feedback signal 120) and the voltage reference 123. The calculated ratio is provided in a ratio signal 124 to a master out module 125 configured to communicate the ratio signal 124 as a master out signal 126 (e.g., a voltage trim output signal) to one or more slave power supply modules coupled to the voltage trim out terminal 121. In a preferred embodiment, the master out module 125 is an output signal generator that includes a pulse width modulation (PWM) module configured to communicate the ratio of the measured output voltage to the reference voltage in a PWM signal where the ratio is indicated by a duty cycle of the PWM signal. A PWM signal includes a high noise immunity. In one embodiment, the duty cycle of the PWM signal is calculated as follows:

$$Duty = ( \frac{{V}_{fb}}{{V}_{rfe}} ) * 0.8 + 0 \text{.05} , \qquad ( Eqn . 1 )$$

where Vfb is the value of the measured output voltage and Vref is the value of the reference voltage. In one embodiment, a minimum duty cycle threshold is set to 0.05, and a maximum duty cycle is set to 0.95. By including minimum and maximum duty cycle thresholds, the controller 111, in a unit functioning as a slave, may determine whether the PWM signal is from a master power supply module or whether the PWM signal is in an error state. For example, if the signal is grounded or is tied to Vcc, the duty cycle will be below 0.05 or above 0.95, and the controller 111 can take appropriate actions like operating the power supply module 100 to temporarily ignore the voltage trim input signal 129 and continue to operate to regulate its output with its default closed-loop control until the PWM signal is restored to working values. Under the master unit configuration, a slave in module 127 is set to output a ratio value signal 128 of 100% regardless of the receipt of any master out signal 126 (e.g. voltage trim input signal 129) on a voltage trim in terminal 130. When combined in a multiplier 131 with the voltage reference 123, the drive control circuit 112 calculates the control signal 108 based on a full value of the voltage reference 123 such as on a comparison of the full value of the voltage reference 123 with the voltage feedback signal 120. An active current sharing control 132 ensures nearly equal current sharing among power supply modules connected in parallel by using current information of a controlling PSU (via a current share bus 133) and comparing with its own output current. Its output signal is provided to a summer 134 and is added with the ratio module 122 and provided to the multiplier 131.

When configured as a slave unit, the CC control module 114 and CP control module 115 are disabled, and the power supply module 100 is configured to operate solely in the CV mode via control of the CV control module 113. A master control signal provided by a master unit and received on the voltage trim in terminal 130 is processed by the slave in module 127 to interpret the calculated ratio (e.g., by the ratio signal 124 determined by the master unit). In one embodiment, the slave in module 127 determines the ratio of the master unit as follows:

$$Ratio = ( \frac{Duty - 0.05}{0.8} ) , \qquad ( Eqn . 2 )$$

where Duty is the duty cycle (in percentage) of the received PWM signal. The ratio value signal 128 is multiplied with the voltage reference 123 via the multiplier 131 such that the drive control circuit 112 controls the CV control module 113 based on the same voltage ratio as experienced by the master unit that is communicated by the master out signal 126. While described as having PWM circuitry to encode and decode the ratio signal 124, other embodiments may include alternative arrangements and be based on analog voltage signals, communication protocol signals, or the like.

The decision to operate as a master unit or as a slave unit may be determined by the controller 111. In one embodiment, the controller 111 uses fixed hardware such as logic level hardware (e.g., short or pull-up pins), analog voltage level hardware (e.g., resistor divider), or hardware logic or analog addressing. In another embodiment, a communications terminal 135 may receive a hardware logic or analog addressing signal via a communications module 136. In addition, a digital address may be received. In another embodiment, a position of the power supply module 100 within a multi-module PSU may be determined. Based on the position being coupled with the system ground or having a floating, power ground, the power supply module 100 may determine its master or slave status. For example, a master unit is preferred to be coupled with the power ground whereas a slave unit has a floating ground as determined by a series connection of the multiple power supply modules.

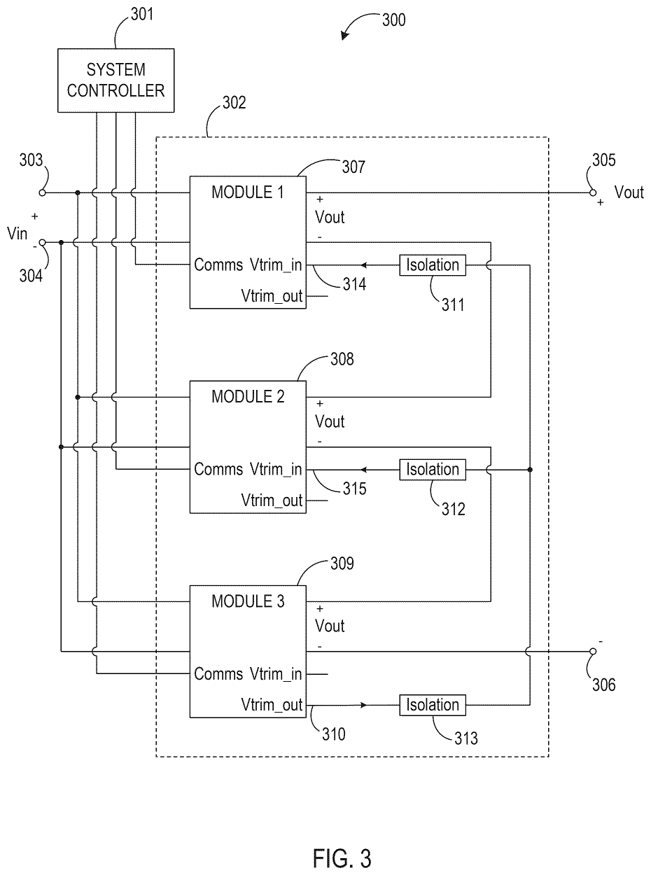

An example of such a multiple power supply module power supply is illustrated in FIG. 3. The power supply system 300 of FIG. 3 includes a system controller 301 and a power supply unit 302. The power supply unit 302 is configured to convert incoming power on power input terminals 303, 304 into outgoing power on power output terminals 305, 306. In one embodiment, a power requirement for the power supply unit 302 is greater than any one power supply module. Accordingly, a series arrangement of a plurality of power supply module 307, 308, 309 is provided. The power supply module 309 has a positive output terminal coupled in series with a negative output terminal of the power supply module 308, which has a positive output terminal coupled in series with a negative output terminal of the power supply module 307. In this manner, the output powers of each of the power supply modules 307, 308, 309 may be combined in an additive manner. The system controller 301 may set up the arrangement of the power supply modules 307, 308, 309 via addressing that, in one embodiment, identifies to the respective power supply module its master or slave status. In another embodiment, power supply module 309 may determine its connection to a power ground and set itself up as a master unit while power supply modules 307, 308 determine their connections to floating grounds and their operations as slave units.

The communication of the master out signal 126 (see FIG. 1) via a trim out terminal 310 of power supply module 309 may be passed through a series of isolation modules 311, 312, 313 as shown to respective trim in terminals 314, 315 of power supply modules 307, 308. For example, due to having floating grounds, the power supply modules 307, 308 may benefit from isolation modules 311, 312 that convert the received master out signal 126 to the respect grounds of the power supply modules 307, 308. The isolation modules 311, 312, 313 may be, for example, optocouplers, linear isolators, isolated drivers, or digital communication modules configured to communicate using protocols such as UART, CAN, or the like.

In the series arrangement illustrated in the power supply unit 302, the output power provided to the power output terminals 305, 306 is a series combination of the power outputs of the three power supply modules 307, 308, 309. Based on operation of the power supply modules 307, 308, 309 using the master and slave modes as described herein, the output power can be preferably equally shared among the power supply modules 307, 308, 309 such that each provides one third of the total provided output power of the power supply unit 302. The master unit (e.g., power supply module 309) communicates the master out signal 126 with the intent of causing the slave units (e.g., power supply modules 307, 308) to follow the same output voltage/current values as the master unit. By operating in the CV mode only, the slave units are able to match the output voltage/current communicated by the master unit. Whether the master unit is controlled to generate the control signal 108 by the CV control module 113, the CC control module 114, or the CP control module 115, the slave units may ignore any CP or CC threshold values and concentrate only on producing the indicated voltage based on the ratio provided by the master unit. In another embodiment, the slave units may apply a buffer to the CP and/or CC threshold values such that the CP and CC modes are never entered into while receiving a master out signal 126 from a master unit. For example, the CC threshold may be set to 110% of a predetermined value. In this manner, the slave unit may have some CC control should the master unit fail to send the master out signal 126 or should the slave in module 127 detect a fault in the master out signal 126.

When the power supply modules 307, 308, 309 are connected in series as shown, the master unit (e.g., power supply module 309) controls the output voltage of the slave units (e.g., power supply modules 307, 308) through the voltage trim out terminal 121 such that the slave units are proportionally adjusted to reflect the reduction in the total output voltage of the series-connected modules when the PSU is operating in CC mode. This ensures that the slave units that are operating in CV mode are able to participate in the overall CC mode by proportionally adjusting down their output voltage using VTRIM information. In addition, the total output voltage of the series-connected modules is increased during PSU-to-PSU current sharing, which ensures that the slave units participate in the PSU-to-PSU current sharing by proportionally increasing their output voltage using VTRIM information.

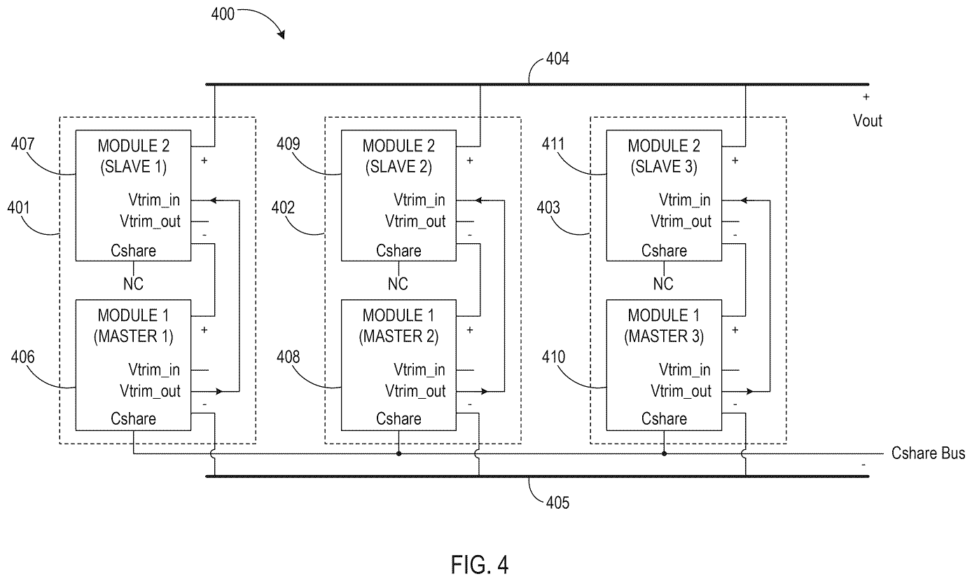

FIG. 4 illustrates another example of a multiple power supply module power supply system 400. The power supply system 400 includes a plurality of power supply units 401, 402, 403 coupled in parallel to an output voltage bus 404, 405. Each power supply unit 401, 402, 403 includes a pair of series coupled power supply modules. Power supply unit 401 includes power supply modules 406, 407. Power supply unit 402 includes power supply modules 408, 409. Power supply unit 403 includes power supply modules 410, 411. Each power supply unit 401, 402, 403 has one master power module (e.g., respectively, power supply modules 406, 408, and 410) and has one slave power module (e.g., respectively, power supply modules 407, 409, and 411). The master power modules 406, 408, and 410 operate independently of each other as described herein and only control their respective slave power modules 407, 409, and 411 within each power supply unit 401, 402, 403 to control both their power output as well as the power output of the slave modules 407, 409, and 411 to provide a total power output of the power supply units 401, 402, 403 equal to the power of the output voltage bus 404, 405.

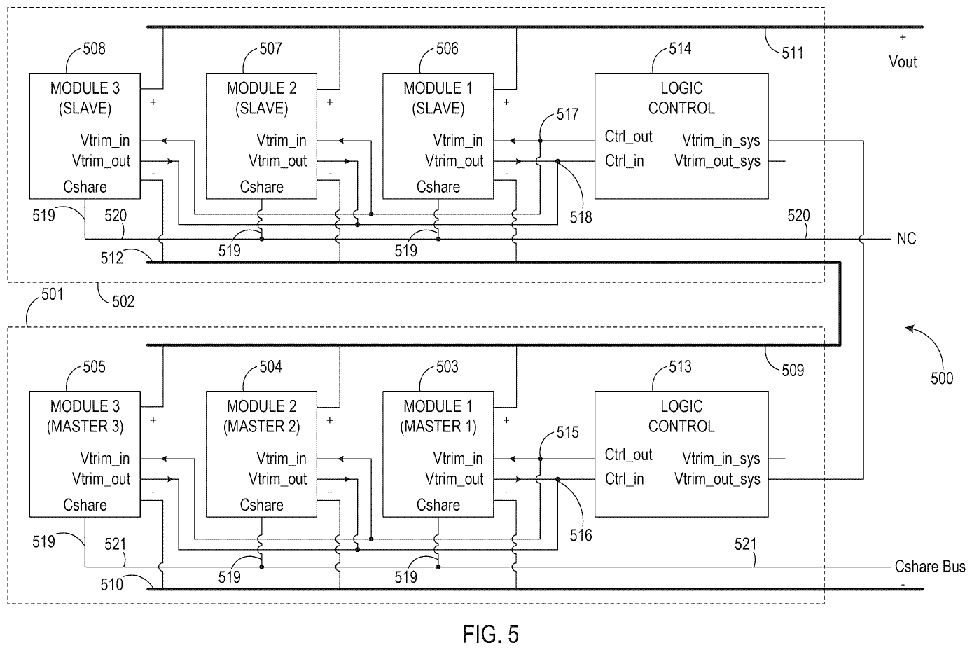

FIG. 5 illustrates another example of a multiple power supply module power supply system 500. The power supply system 500 has two power supply units 501, 502 coupled in series. Within each power supply unit 501, 502 three power supply modules are coupled in parallel. The power supply unit 501 includes parallel-coupled power supply modules 503, 504, 505. The power supply unit 502 includes parallel-coupled power supply modules 506, 507, 508. The power supply modules 503-505 are configured to provide parallel output power to an output voltage bus 509, 510 of the power supply unit 501, and the power supply modules 506-508 are configured to provide parallel output power to an output voltage bus 511, 512 of the power supply unit 502. The output voltage bus 509 is serially coupled with the output voltage bus 512 to create a series connection between the power supply units 501, 502.

Each power supply unit 501, 502 also includes a logic control module 513, 514 configured to control master out signal 126 propagation. In the power supply unit 501, the voltage trim in terminals 130 of the power supply modules 503-505 are coupled together to a trim in bus 515. The voltage trim out terminals 121 are coupled together to a trim out bus 516. The voltage trim in terminals 130 of the power supply modules 506-508 of the power supply unit 502 are coupled together to a trim in bus 517, and the voltage trim out terminals 121 are coupled together to a trim out bus 518.

Based on the configuration of the power supply units 501, 502, the power supply modules 503-505 may determine that each is a master unit configured to operate as such as described herein. The logic control module 513, connected to the power supply modules 503-505, is configured to determine which of the three modules should act as a master unit for the power supply modules 506-508 of the power supply unit 502. In this manner, even though each power supply module 503-505 acts as though it is a master unit, the logic control module 513 sends only one of the master out signals 126 to the power supply unit 502. The logic control module 513 determines which module is the master unit in a given PSU and may do so by assignment such as through sequencing, for example. In response to receiving the selected master out signal 126 from the logic control module 513, the logic control module 514 transmits the selected master out signal 126 to each of the power supply modules 506-508 that are set up as slave units. Based on slave unit operation as described herein, each of the power supply modules 506-508 uses the transmitted master out signal 126 to control its CV mode operation.

Power supply modules 506-508 operate in the CV mode using the VTRIM_IN signal (SLAVE) to adjust its internal reference. In order to control current sharing between modules, a current share signal 519 is shared between each module within the PSU 502 via a current share bus 520. The current share bus 520 connects the power supply modules 506-508 but is has no connection (NC) with any other component outside of the PSU 502. Power supply modules 503-505 operate in the master mode and operate independently from each other. Current sharing between the power supply modules 503-505 includes sharing the current share signal 519 on a current share bus 521. If PSUs 501 and 502 are paralleled with another group of PSUs, the same current share signal shared between 503-505 on the current share bus 521 will be connected to the other PSU groups since they share the same ground.

Embodiments of this disclosure provide several advantages. New systems-level architecture for building modules and PSUs into higher voltage and higher power configurations. Embodiments address control complexity having multiple modules (e.g., two or more) that are connected in series inside a PSU that is made to operate in CC mode. Individual module sensing tolerances no longer affect one another. Several embodiments address module interaction and avoid hunting conditions in power supply modules. Master/Slave module function is agnostic since each module will be programmed with both functionality and will be pre-selected depending on module slot/addressing, which allows for uniform manufacturing of modules. Balanced power delivery is maintained among modules connected in series during overall CC mode with one acting as master module controlling the CC operation while the rest of the slave modules in series are copying or proportionally tracking the target voltage regulation. During active current sharing of parallel power supplies (with series modules), the slave modules will have the same output voltage adjustment as the master to provide same power delivery. In series configuration, the CC mode set-point of the slave units is increased to allow the master unit to go into the CC mode first and can automatically prevent the slave units going into the CC mode. Output voltage adjustability is simpler since only one module dictates and the rest follow target voltage regulation through VTRIM. Complexity during current sharing of PSUs is also reduced. The total output voltage set-point error adjustment (due to the difference in module output voltage regulation, cable loss, interconnection loss) can be implemented through the master module using differential output sensing.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. A power supply module comprising:
a voltage input adapted to receive an input voltage;
a voltage converter configured to convert the input voltage into an output voltage;
a voltage output adapted to receive the output voltage;
a controller comprising:
a voltage trim input configured to receive a voltage trim input signal from a master power supply module;
a voltage trim output configured to output a voltage trim output signal to a slave power supply module;
a drive control circuit configured to generate a converter control signal based on the voltage trim input signal, the converter control signal configured to control an operation of the voltage converter; and
an output signal generator configured to generate the voltage trim output signal based on the output voltage.

2. The power supply module of claim 1, wherein the output signal generator comprises a ratio generator configured to calculate a ratio between a reference voltage and the output voltage; and
wherein the output signal generator is configured to generate the voltage trim output signal based on the ratio.

3. The power supply module of claim 2, wherein the output signal generator comprises a pulse width modulation (PWM) signal generator configured to generate the voltage trim output signal as a PWM signal.

4. The power supply module of claim 2, wherein the controller further comprises:
a voltage feedback circuit configured to provide a voltage feedback signal to the drive control circuit and to the ratio generator;
wherein the voltage feedback signal is based on the output voltage.

5. The power supply module of claim 1, wherein the drive control circuit comprises:
a constant voltage control module configured to generate the converter control signal to control operation of the voltage converter in a constant voltage source mode; and
a constant current control module configured to generate the converter control signal to control operation of the voltage converter in a constant current source mode.

6. The power supply module of claim 5, wherein the drive control circuit further comprises a constant power control module configured to generate the converter control signal to control operation of the voltage converter in a constant power source mode.

7. The power supply module of claim 5, wherein the controller is configured to operate in a master mode; and
wherein, in response to the operation of the controller in the master mode, the drive control circuit is configured to:
control the constant voltage control module to generate the converter control signal to control operation of the voltage converter in the constant voltage source mode in response to an output current of the voltage converter being less than a constant current threshold; and
control the constant current control module to generate the converter control signal to control operation of the voltage converter in the constant current source mode in response to the output current being greater than the constant current threshold.

8. The power supply module of claim 7, wherein the controller is configured to operate in a slave mode; and
wherein, in response to the operation of the controller in the slave mode, the drive control circuit is configured to:
control the constant voltage control module to generate the converter control signal to control operation of the voltage converter in the constant voltage source mode in response to the voltage trim input signal.

9. The power supply module of claim 7 further comprising a current sense resistor coupled to the voltage converter; and
wherein the controller further comprises a current feedback circuit configured to measure the output current and provide a current feedback signal to the drive control circuit based on the output current.

10. A method of controlling a power supply system including first and second power supply modules, each of the first and second power supply modules configured to convert an input power into an output power and comprising a controller configured to operate in a constant voltage source mode and in a constant current source mode, the method comprising:
operating the first power supply module according to a master operational mode comprising:
detecting an output voltage of the output power;
generating a first converter control signal based on the output voltage and based on a first reference voltage;
controlling the first power supply module based on the first converter control signal to generate the output power of the first power supply module;
generating a voltage trim output signal based on the output voltage and based on the first reference voltage; and
transmitting the voltage trim output signal to the second power supply module; and
operating the second power supply module according to a slave operational mode comprising:
receiving the voltage trim output signal from the first power supply module;
generating a second converter control signal based on the voltage trim output signal and based on a second reference voltage; and
controlling the second power supply module based on the second converter control signal to generate the output power of the second power supply module.

11. The method of claim 10, wherein the first and second power supply modules are coupled in series.

12. The method of claim 10 further comprising:
operating the first power supply module in the constant voltage source mode in response to an output current of the output power being less than a constant current threshold; and
operating the first power supply module in the constant current source mode in response to the output current being greater than the constant current threshold.

13. The method of claim 12 further comprising:
operating the first power supply module in a constant power source mode in response to the output power being equal to a constant power threshold and in response to the output current being less than the constant current threshold.

14. The method of claim 12 further comprising operating the second power supply module only in the constant voltage source mode while the controller of the second power supply module is operated in the slave operational mode.

15. The method of claim 10, wherein generating the voltage trim output signal comprises:
calculating a ratio of the output voltage and the first reference voltage; and
configuring the voltage trim output signal to indicate the ratio.

16. The method of claim 15, wherein configuring the voltage trim output signal comprises generating a pulse width modulation (PWM) signal having a duty cycle based on the ratio.

17. A power supply unit comprising:
a first power supply module coupled in series with a second power supply module, each of the first and second power supply modules configured to convert an input power into a respective output power and comprising a voltage converter and a controller;
wherein the controllers of the first and second power supply modules are configured to:
operate in one of a master operational mode and a slave operational mode based on an operational mode designation;
in response to operating in the master operational mode:
detect an output voltage of the output power of the respective first or second power supply module;
generate a first converter control signal based on the output voltage of the respective first or second power supply module and based on a first reference voltage;
control the respective first or second power supply module based on the first converter control signal to generate the output power of the respective first or second power supply module;
generate a voltage trim output signal based on the output voltage of the respective first or second power supply module and based on the first reference voltage; and
transmit the voltage trim output signal to another power supply module; and
in response to operating in the slave operational mode:
receive the voltage trim output signal;
generate a second converter control signal based on the voltage trim output signal and based on a second reference voltage; and
control the respective first or second power supply module based on the second converter control signal to generate the output power of the respective first or second power supply module.

18. The power supply unit of claim 17, wherein, in response to operating in the master operational mode, the controllers of the first and second power supply modules are configured to:
operate the respective first or second power supply module in a constant voltage source mode in response to an output current of the output power of the respective first or second power supply module being less than a constant current threshold; and
operate the respective first or second power supply module in a constant current source mode in response to the output current of the respective first or second power supply module being greater than the constant current threshold.

19. The power supply unit of claim 17, wherein the operational mode designation comprises one of:
a position of the first and second power supply modules within the power supply unit;
an addressing signal received via a communications module;
logic level hardware; and
analog voltage level hardware.

20. The power supply unit of claim 17, wherein the voltage trim output signal indicates a ratio of the output voltage of the respective first or second power supply module and the first or second reference voltage.
